(19) United States
(12) Patent Application Publication
(10) Pub. No.: US 2013/0100169 A1
(43) Pub. Date: Apr. 25, 2013

(54) INPUT DEVICE AND METHOD FOR ZOOMING AN OBJECT USING THE INPUT DEVICE

(71) Applicants: Jui-Tsung LIAO, New Taipei City (TW); Kun-Hsiung Wu, New Taipei City (TW); Chih-Heng Nien, New Taipei City (TW); Chien-Hsing Tsai, New Taipei City (TW); Shih-Wei Yeh, New Taipei City (TW); Tsu-Nan Lee, New Taipei City (TW); Yu-Chi Wang, New Taipei City (TW)

(72) Inventors: Jui-Tsung LIAO, New Taipei City (TW); Kun-Hsiung Wu, New Taipei City (TW); Chih-Heng Nien, New Taipei City (TW); Chien-Hsing Tsai, New Taipei City (TW); Shih-Wei Yeh, New Taipei City (TW); Tsu-Nan Lee, New Taipei City (TW); Yu-Chi Wang, New Taipei City (TW)

(73) Assignee: KYE SYSTEMS CORP., New Taipei City (TW)

(21) Appl. No.: 13/448,532

(22) Filed: Apr. 17, 2012

(30) Foreign Application Priority Data
Oct. 25, 2011 (TW) 100138612

(51) Int. Cl. G09G 5/00

(52) U.S. Cl. 345/660

(57) ABSTRACT

An input device includes a motion sensor for sensing a first axis value, a distance sensor for sensing a limb distance between two limbs, and a controller. The controller is used to perform a method for controlling zooming of an object. The method includes using the motion sensor to sense the first axis value; and initiating a zooming program when the first axis value meets an initiating condition. The zooming program includes the following steps of using the distance sensor to sense the limb distance between two limbs, comparing the limb distance with a reference value; and based on a comparison result outputting a zooming control signal to zooming of an object.

### CROSS-REFERENCE TO RELATED APPLICATIONS

This non-provisional application claims priority under 35 U.S.C. §119(a) on Patent Application No(s). 100138612 filed in Taiwan, R.O.C. on Oct. 25, 2011, the entire contents of which are hereby incorporated by reference.

### BACKGROUND

1. Technical Field

The disclosure relates to an input device and a method for controlling an object using the input device, and more particularly to an input device and a method for controlling zooming of an object using the input device.

2. Related Art

Now personal computers and laptops are widely used throughout the world and applications are developing diversely. For example, various kinds of operations, calculations, or application software make computers increasingly needed in different fields. The population of using computers is rapidly increasing. There are multiple kinds of input devices for a computer, such as mouse, trackball, touchpad, writing pad or rocking lever. A mouse has been a most popular man-machine interface. A user can use a mouse to control a cursor or scroll window pages of a computer. However, a user cannot only use a mouse to zoom an image or a selected object displayed on a screen of a computer.

An operation system of a computer generally establishes a particular input combination as short-cut keys so as to provide a zooming function. Take the Microsoft window operation system for illustration, scrolling the mousewheel while the “ctrl” key is pressed is regarded as a standard operation for zooming an object. It is not convenient for a user to scroll the mousewheel and pressing the “ctrl” key at the same time. In addition, since different operations, even applications, may set different short-cut keys for the zooming operation, a user needs to familiar with these short-cut keys. In this case, it may be inconvenient for a user to use the short-cut keys. Also, a user may be confused by those uses of short-cut keys.

### SUMMARY

The present disclosure provides a method for controlling zooming of an object using an input device. The method comprises using a motion sensor of the input device to sense a first axis value; and initiating a zooming program when the first axis value meets an initiating condition. The zooming program comprises the following steps: using a distance sensor of the input device to sense a limb distance between two limbs; comparing the limb distance with a reference value; and based on a comparison result outputting a zooming control signal for zooming the object.

The present disclosure further provides an input device, comprising a motion sensor for sensing a first axis value; a distance sensor for sensing a limb distance between two limbs; and a controller for comparing the first axis value with an initiating condition and initiating a zooming program when the first axis value meets the initiating condition. The zooming program comprises the following steps: using the distance sensor to sense the limb distance between the two limbs; comparing the limb distance with a reference value; and based on a comparison result outputting a zooming control signal to zoom the object.

### BRIEF DESCRIPTION OF THE DRAWINGS

The present disclosure will become more fully understood from the detailed description given herein below for illustration only, and thus are not limitative of the present disclosure, and wherein:

FIG. 1 is a block diagram for an input device according to an embodiment;

FIG. 2 is a block diagram for a motion sensor according to an embodiment;

FIG. 3 illustrates a limb distance according to an embodiment;

FIG. 4A illustrates a distance sensor according to an embodiment;

FIG. 4B illustrates a distance sensor according to anther embodiment;

FIG. 5 is a flowchart for a method for controlling zooming of an object;

FIG. 6 illustrates an initiating condition according to an embodiment;

FIG. 7 is a flowchart for a zooming program according to an embodiment;

FIG. 8A is a flowchart for an ordinary zooming program according to an embodiment;

FIG. 8B is a flowchart for a continuously zooming in program according to an embodiment;

FIG. 8C is a flowchart for a continuously zooming out program according to an embodiment;

FIG. 9 is a flowchart for a method for controlling zooming of an object according to an embodiment;

FIG. 10A illustrates a second axis value according to an embodiment;

FIG. 10B illustrates a second axis value according to another embodiment;

FIG. 11 is a flowchart for a zooming program according to an embodiment;

FIG. 12 is a flowchart for a method for controlling zooming of an object according to an embodiment; and

FIG. 13 is a flowchart for an ordinary zooming program according to an embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the following embodiments, the characteristics and merits of the present disclosure will be described in detail. According to the following descriptions, persons skilled in the art can know the technical content based on which the disclosure can be implemented. Furthermore, persons skilled in the art can easily understand the purpose and merits of the disclosure according to the disclosure of the specification, claims, and the appended drawings.

The present disclosure provides an input device and a method for controlling zooming of an object using the input device, so that users can control the input device directly and use the input device to zoom an object displayed on a screen of a computer. For example, the object may be a webpage, a window procedure page, an image, or an object selected in applications such as Paintbrush for Windows.

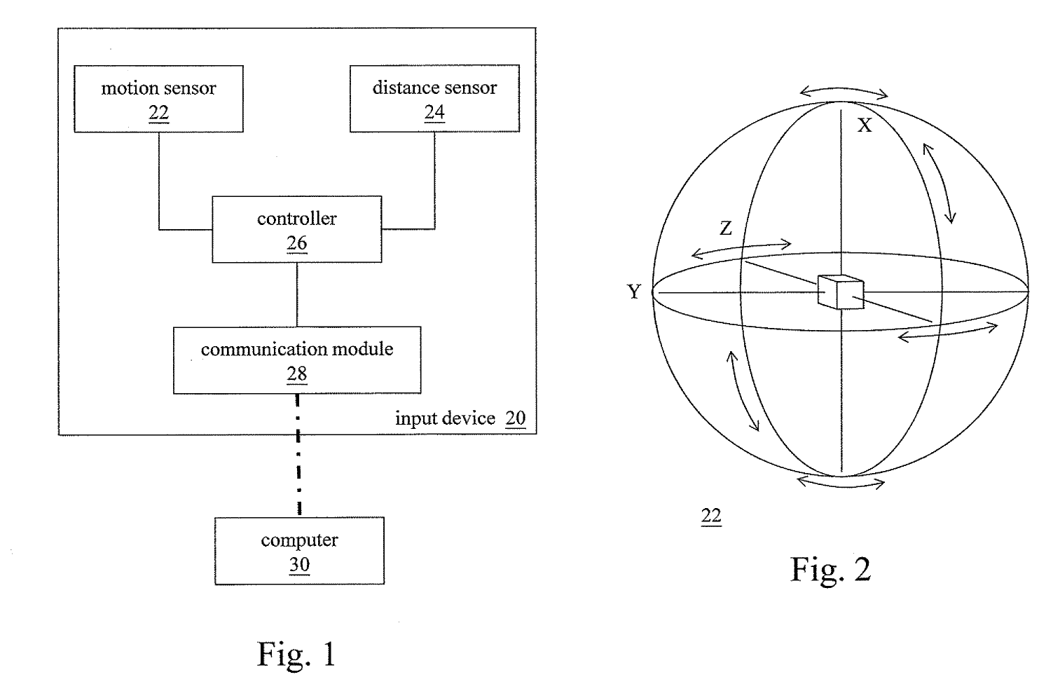

FIG. 1 is a block diagram for an input device according to an embodiment. The input device 20 includes a motion sensor 22, a distance sensor 24, and a controller 26.

The motion sensor 22 may be a G-force sensor or a gyroscope. The motion sensor 22 can sense the acceleration or the angular velocity of the input device 20 and thus output a signal as a first axis value. FIG. 2 is a block diagram for a motion sensor according to an embodiment. The motion sensor in FIG. 2 is a G-force sensor with three axes. The motion sensor can detect accelerations along axes X, Y, and Z and output signals, i.e. a first axis value, a second axis value, and a third axis value. In addition, the input device 20 can empoly a multiple-axis G-force sensor or gyroscope or a single-axis G-force sensor or gyroscope but not limited thereto in order to perform motion detection.

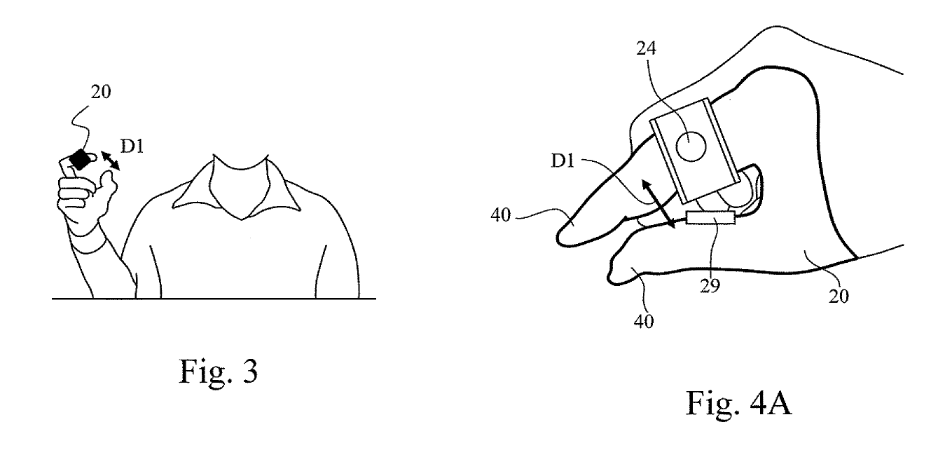

The distance sensor 24 is used to sense a limb distance between two limbs of a user. The two limbs of a user may be for example a forefinger and a thumb of one hand, two forefingers of two hands, or two palms. That is, the distance sensor 24 can sense the distance between a forefinger and a thumb of one hand (as shown in FIG. 3), two fingers of two hands, or two palms. The following disclosure is described for the example of a forefinger and a thumb of one hand, but the disclosure is not limited thereto.

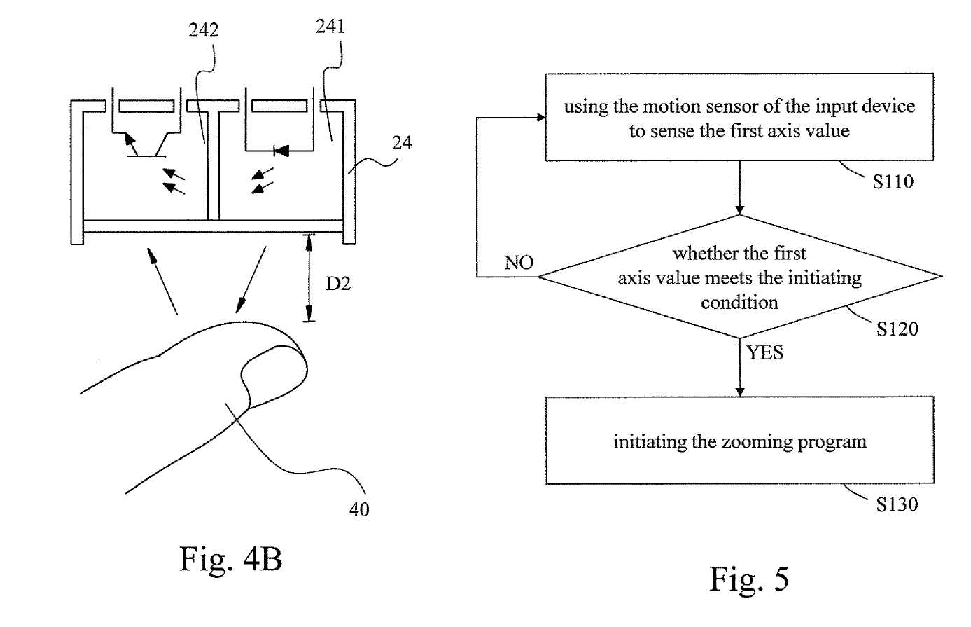

The distance sensor 24 may be a hall sensor, an infrared transceiver, a laser transceiver, or an ultrasonic transceiver. FIGS. 4A and 4B illustrate distance sensors and limb distances according to different embodiments. The distance sensor in FIG. 4A is a hall sensor. The input device 20 can be made as a fingerstall covering the forefinger and the thumb of one hand. The hall sensor (or the distance sensor) 24 may be disposed on a ring-shape main body. A magnet 29 can be disposed at the thumb portion of the fingerstall. However, the distance sensor 24 and the magnet 29 can also be respectively disposed on other limbs of a user. Since the outputted voltage value based on a detected magnetic force is substantially in inverse proportion of the distance between the hall sensor and the magnet 29, the input device 20 can measure the distance Dl between two limbs 40 (i.e. the forefinger and the thumb) and regard D1 as the limb distance.

The distance sensor 24 in FIG. 4B is an infrared transceiver. The distance sensor 24 may include a transmit unit 241 and a receiver unit 242 which are disposed near each other. For example, the transmit unit 241 may be a light emitting diode emitting infrared rays, and the receiver unit 242 may be a photosensitive diode which converts the infrared rays into electrical signals. Both the transmit unit 241 and the receiver unit 242 are disposed on a forefinger of a user. The transmit unit 241 can be configured to emit infrared rays towards a thumb, while the receiver unit 242 receives infrared rays reflected from the thumb. A voltage representing the limb distance may be outputted according to the intensity of the reflected infrared rays. In addition, the transmit unit 241 also can emit laser or ultrasonic to measure the limb distance. Simply to say, the transmit unit 241 and the receiver unit 242 may be disposed on a same limb 40, and the transmit unit 241 emits infrared rays, laser, or ultrasonic towards anther limb 40.

The controller 26 is used to perform a method for zooming an object. FIG. 5 is a flowchart for a method for controlling zooming of an object.

The controller 26 firstly senses the first axis value using the motion sensor 22 of the input device 20 (S110). In other words, the controller 26 reads the first axis value outputted from the motion sensor 22. The controller 26 then compares the first axis value with an initiating condition to determine whether the first axis value meets the initiating condition (S210). When the first axis value meets the initiating condition, the controller 26 initiates a zooming program.

The initiating condition may be that “a user puts up the input device so that the angle between the line connecting the input device and the chest of the user and a horizontal line is greater than a preset initial angle” or that “a user quickly swings the input device once”, and the like.

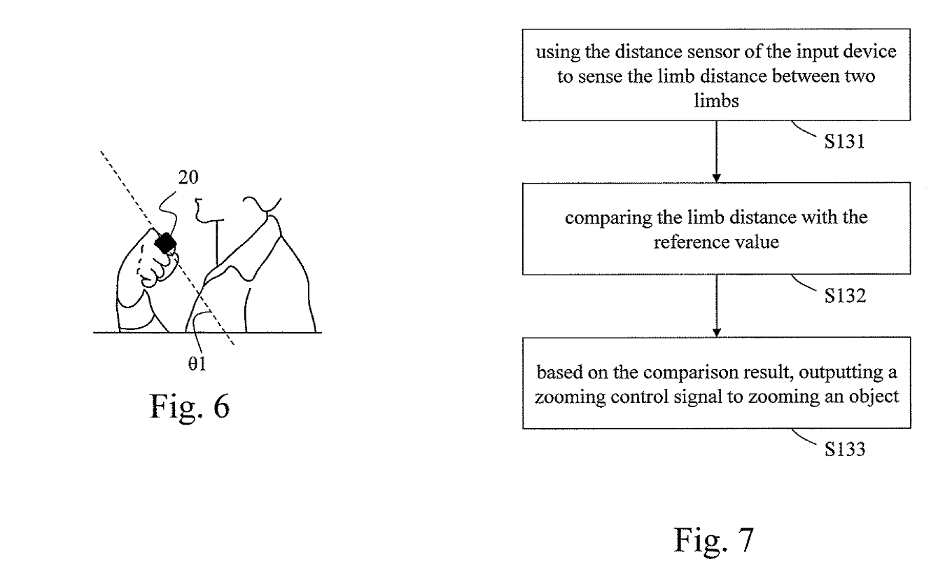

Take FIG. 6 for illustration, if the signal outputted according to the acceleration of axis X as shown in FIG. 2 is regarded as the first axis value, the controller 26 may read the first axis value and consider it as the angle θ1 between the line connecting the input device 20 and the chest of the user and a horizontal line. When θ1 is greater than a preset initial angle (e.g., 45°), the zooming program is initiated.

In some embodiments, the initiating condition is “a user quickly swings the input device once”. If the motion sensor 22 is a G-force sensor, it is determined that the user has quickly swung the input device once when the controller 26 reads an acceleration with opposite direction to and greater than a default acceleration in a short time period (e.g., one second). If the motion sensor 22 is a gyroscope, it is determined that the user has quickly swung the input device once when the controller 26 senses an angular velocity variation with opposite direction to and greater than a default angular velocity variation in a short time period (e.g., one second).

When the first axis value meets the initiating condition, the controller 26 initiates the zooming program and enters a zooming mode. FIG. 7 is a flowchart for a zooming program according to an embodiment.

During the zooming program, the controller firstly uses the distance sensor 24 of the input device 20 to sense the limb distance between two limbs (S131). Then the controller 26 compares the limb distance with a reference value (S132). Based on the comparison result, a zooming control signal is outputted to zoom objects (S133). In other words, the zooming program can zoom objects according to the limb distance between two limbs 40. Furthermore, the input device may further comprise a communication module 28 which outputs the zooming control signal to a computer 30 in a wired or wireless way.

The controller 26 may consider a default value of a memory or the limb distance sensed at last time as the reference value. A zooming program may further comprise a step of recording the limb distance as the reference value. According to one embodiment, the zooming program may successively sense the limb distance for two times before the step S132, and consider the limb distance sensed last time as the reference value. In the step S133, the zooming program compares the limb distance sensed last time with that sensed immediately after that time. The following embodiments regard the limb distance sensed last time as the reference value.

According to different embodiments, the zooming program may be an ordinary zooming program, a continuously zooming in program, or a continuously zooming out program. These programs respectively correspond to an ordinary zooming mode, a continuously zooming in mode, and a continuously zooming out mode.

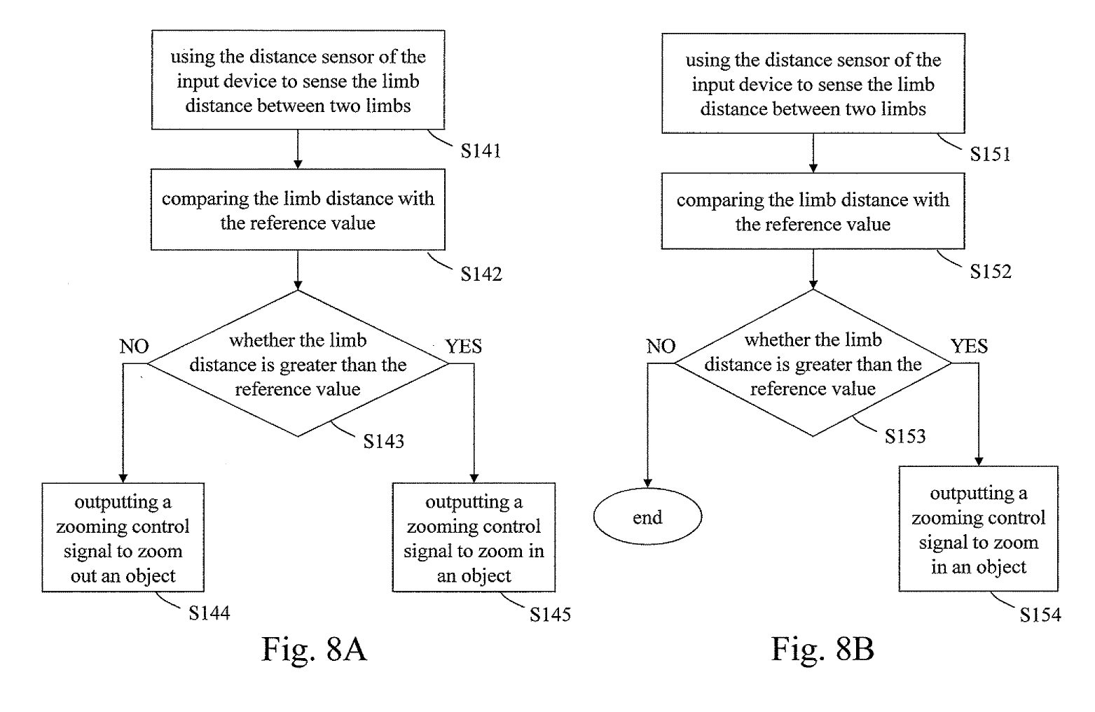

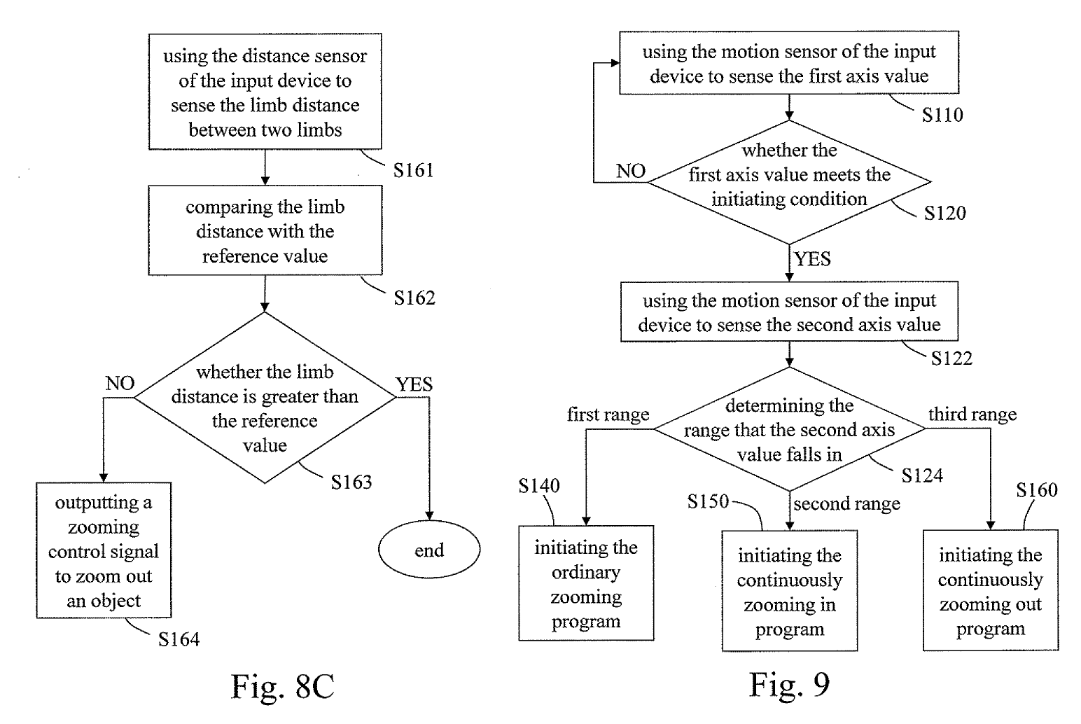

FIGS. 8A, 8B, and 8C are flowcharts respectively showing an ordinary zooming program, a continuously zooming in program, and a continuously zooming out program.

With respect to the ordinary zooming program, in FIG. 8A, the controller 26 uses the distance sensor 24 to sense the limb distance between two limbs 40 (S141). Then the program compares the limb distance with the reference value (S142) to determine whether the limb distance is greater than the reference value (S143). When the limb distance is not greater than the reference value, the controller 26 output a zooming control signal to zoom out objects (S144). On the contrary, when the limb distance is greater than the reference value, the controller 26 output a zooming control signal to zoom in objects (S145). Therefore, when using the limb distance sensed last time as the reference value, a user can zoom in or zoom out objects by pulling away or pulling close two limbs.

With respect to the continuously zooming in program,in FIG. 8B, the controller 26 uses the distance sensor 24 to sense the limb distance between two limbs 40 (S151). Then the program compares the limb distance with the reference value (S152) to determine whether the limb distance is greater than the reference value (S153). When the limb distance is greater than the reference value, the controller 26 may output a zooming control signal to zoom in objects (S154). However, when the limb distance is not greater than the reference value, the controller 26 does not do anything. According to another embodiment, when the limb distance is not greater than the reference value, the program returns to the step S151. In such a way, the continuously zooming in mode can only zoom in but not zoom out objects. Therefore, for example, when the forefinger and the thumb of one hand cannot be pulled away further, a user can also zoom in objects by pulling close and then pulling away the two fingers again. While the user pulls close the two fingers, objects will not be zoomed out.

With respect to the continuously zooming out program, in FIG. 8C, during, the controller 26 uses the distance sensor 24 to sense the limb distance between two limbs 40 (S161). Then the program compares the limb distance with the reference value (S162) to determine whether the limb distance is greater than the reference value (S163). When the limb distance is not greater than the reference value, the controller 26 may output a zooming control signal to zoom out objects (S164). However, when the limb distance is greater than the reference value, the controller 26 does not do anything. Contrary to the continuously zooming in mode, the continuously zooming out mode can only zoom out but not zoom in objects. Therefore, even if the forefinger and the thumb of one hand have contacted to each other, a user can also zoom out objects by pulling away and then pulling close the two fingers again.

The above described ordinary zooming program, the continuously zooming in program, and the continuously zooming out program can be performed in a single embodiment. FIG. 9 is a flowchart for a method for controlling zooming of an object according to an embodiment. In this embodiment, after the step S120, the controller 26 further uses the motion sensor 22 of the input device 20 to sense a second axis value (S122) to determine a range for the second axis value (S124).

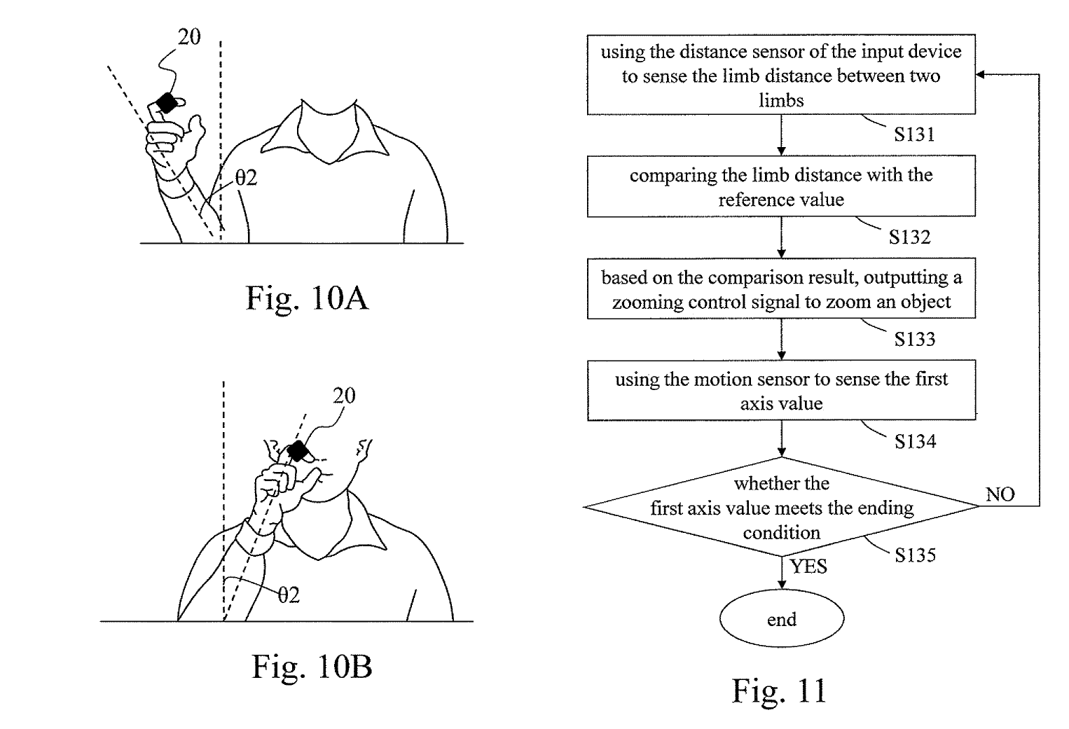

FIGS. 10A and 10B illustrate the second axis value according to different embodiments.

For example, the signal outputted according to the acceleration of axis Y as shown in FIG. 2 may be regarded as the second axis value, which is shown by the angle θ2 between the forearm and the vertical line. The input device 20 can preset the second axis value when a user swings the forearm towards the right so that the angle θ2 exceeds 20° as a first range for the second axis value (FIG. 10A), and the second axis value when a user swings the forearm towards the left so that the angle θ2 exceeds 20° as a second range for the second axis value (FIG. 10B). Other angles except for those of the first and second ranges are preset as a third range of the second axis value. When the second axis value falls in the first, second, or third range, the controller 26 respectively initiates the ordinary zooming program (S140), the continuously zooming in program (S150), or the continuously zooming out program (S160).

In addition, the zooming program can be performed repeatedly. FIG. 11 is a flowchart for a zooming program according to an embodiment. After outputting the zooming control signal, the controller 26 may use the motion sensor 22 to again sense the first axis value (S134) and determine whether the first axis value meets an ending condition (S135). The ending condition may be that for example “a user puts down the input device so that the angle between the line connecting the input device and the chest of the user and a horizontal line is smaller than a preset ending angle”. When the angle θ1 is smaller than the preset ending angle (e.g. 30°), the zooming program ends. On the contrary, as long as the angle θ1 is not smaller than the present ending angle, the zooming program returns to the step S131 to again sense the limb distance in order to zoom an object.

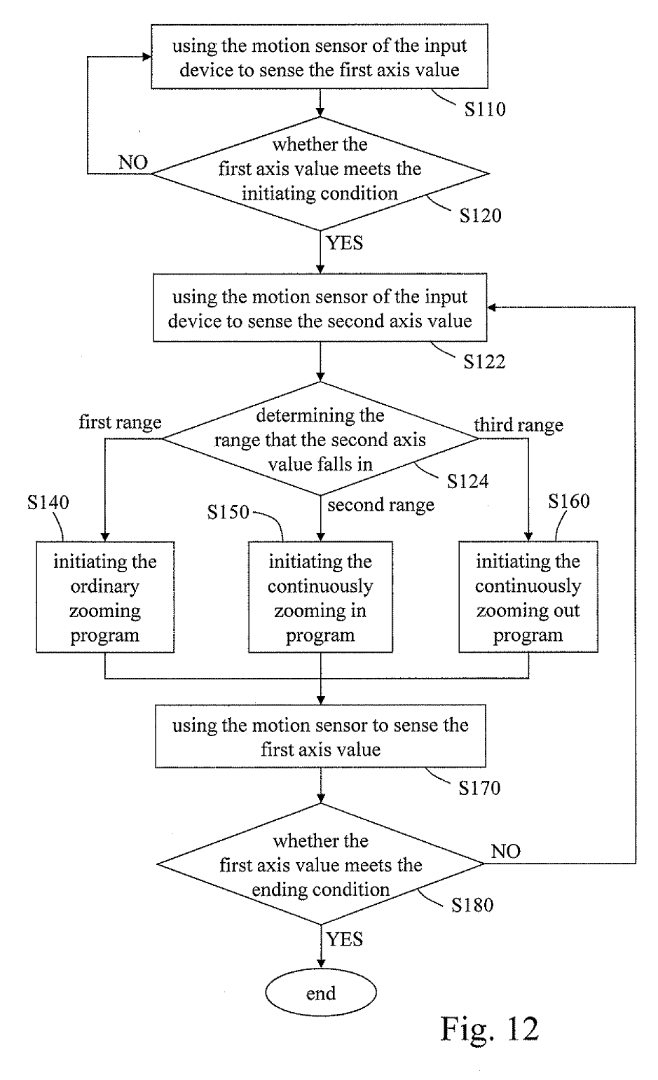

The above described repeatedly performed zooming program can also be implemented in the main program for the method for zooming of an object, as shown by FIG. 12. After performing an ordinary zooming program, a continuously zooming in program, or a continuously zooming out program, the controller 26 can use the motion sensor 22 to sense again the first axis value (S170) and determine whether the first axis value meets the ending condition (S180). When the first axis value does not meet the ending condition, the main program returns to the step S122 to determine whether a user has moved the input device 20 and thereby initiate a corresponding zooming program.

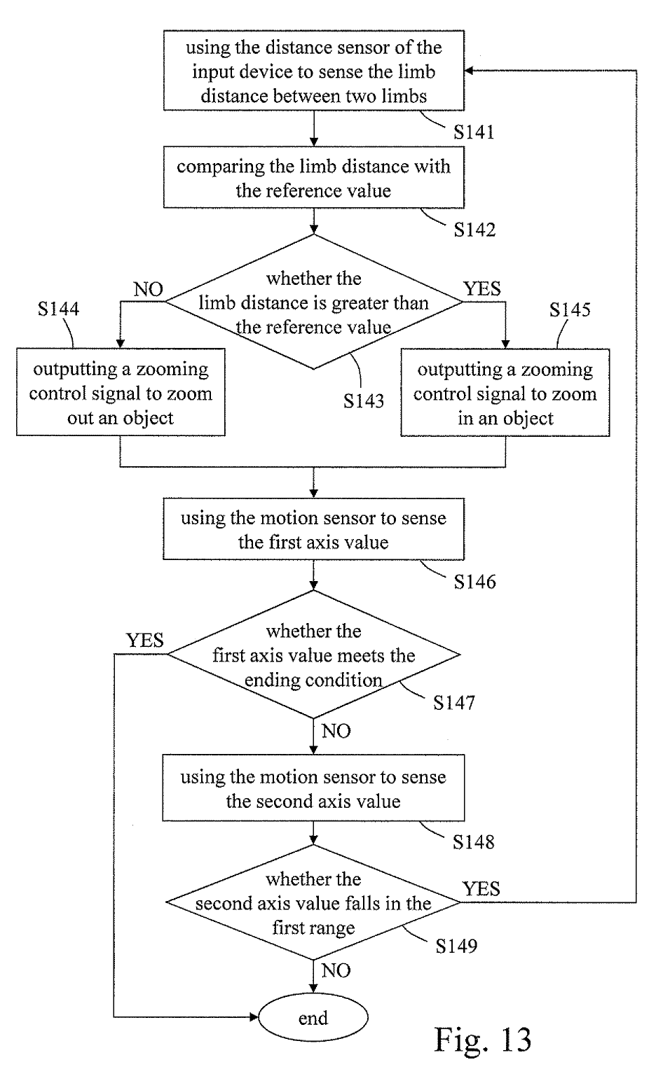

According to an embodiment, it can be determined whether to repeatedly perform an ordinary zooming program, a continuously zooming in program, or a continuously zooming out program or initiate other zooming programs. FIG. 13 is a flowchart for an ordinary zooming program according to an embodiment. With reference to FIG. 13, after outputting the zooming control signal, the controller 26 further uses the motion sensor 22 to sense again the first axis value (S146) and determine whether the first axis value meets the ending condition (S147). When the first axis value does not meet the ending condition, the controller 26 uses the motion sensor 22 to sense the second axis value (S148) and determine whether the second axis value falls in the first range (S149). If the second axis value is in the first range, the ordinary zooming mode remains and the ordinary zooming program returns to the step S141 to zoom objects according to the limb distance. However, if the second axis value falls in the third range, the controller 26 ends the ordinary zooming program (i.e., jumping out of the ordinary zooming mode). The controller 26 initiates a continually zooming in program or a continuously zooming out program according to the range that the second axis value falls in at present.

Similarly, a continually zooming in program or a continuously zooming out program also may comprise determining steps similar to the step S146 to the step S149 to determine whether a user intends to end a zooming mode.

Based on the above, the motion sensor can automatically detect a zooming mode that a user intends to use. The controller can zoom objects according to the limb distance sensed by the distance sensor. People often use their limb distance between the forefinger and the thumb or between two palms to describe the size of an object. Zooming programs can use such limb distances to zoom objects. The input device and the method for zooming an object according to the present disclosure provide users a simple, quick, and direct zooming method. In this case, users can zoom objects on a screen of a computer by gestures for communication in daily life without remembering various shortcut-keys in different operation systems or applications.

What is claimed is:

1. A method for controlling zooming of an object using an input device, the method comprising:
using a motion sensor of the input device to sense a first axis value; and
initiating a zooming program when the first axis value meets an initiating condition, wherein the zooming program comprises the following steps:
using a distance sensor of the input device to sense a limb distance between two limbs;
comparing the limb distance with a reference value; and
based on a comparison result outputting a zooming control signal to zooming the object.

2. The method according to claim 1, wherein initiating a zooming program when the first axis value meets an initiating condition comprises:
when the first axis value meets the initiating condition, using the motion sensor of the input device to sense a second axis value; and
when the second axis value falls in a first range, initiating an ordinary zooming program, wherein the ordinary zooming program comprises the following steps:
using the distance sensor to sense the limb distance between two limbs;
comparing the limb distance with the reference;
if the limb distance is greater than the reference, outputting the zooming control signal to zoom in the object; and
if the limb distance is not greater than the reference, outputting the zooming control signal to zoom out the object.

3. The method according to claim 1, wherein initiating a zooming program when the first axis value meets an initiating condition comprises:
when the first axis value meets the initiating condition, using the motion sensor of the input device to sense a second axis value; and
when the second axis value falls in a second range, initiating a continuously zooming in program, wherein the continuously zooming in program comprises the following steps:
using the distance sensor to sense the limb distance between two limbs;
comparing the limb distance with the reference;
if the limb distance is greater than the reference, outputting the zooming control signal to zoom in the object.

4. The method according to claim 1, wherein initiating a zooming program when the first axis value meets an initiating condition comprises:
when the first axis value meets the initiating condition, using the motion sensor of the input device to sense a second axis value; and
when the second axis value falls in a third range, initiating a continuously zooming out program, wherein the continuously zooming out program comprises the following steps:
using the distance sensor to sense the limb distance between two limbs;
comparing the limb distance with the reference;
if the limb distance is not greater than the reference, outputting the zooming control signal to zoom out the object.

5. The method according to claim 1, wherein after the step of based on the comparison result outputting the zooming control signal to zooming the object the zooming program further comprises the following steps:
using the motion sensor to sense the first axis value;
when the first axis value meets an ending condition, ending the zooming program; and
when the first axis value does not meet the ending condition, returning to the step of using the distance sensor of the input device to sense the limb distance between the two limbs.

6. The method according to claim 5, wherein the reference value is the limb distance sensed last time.

7. An input device, comprising:
a motion sensor for sensing a first axis value;
a distance sensor for sensing a limb distance between two limbs; and
a controller for comparing the first axis value with an initiating condition, and initiating a zooming program when the first axis value meets the initiating condition, wherein the zooming program comprises the following steps:
using the distance sensor to sense the limb distance between the two limbs;
comparing the limb distance with a reference value; and
based on a comparison result outputting a zooming control signal to zoom the object.

8. The input device according to claim 7, wherein the controller compares the first axis value with the initiating condition, when the first axis value meets the initiating condition, the controller senses a second axis value, and when the second axis value falls in a first range, the controller initiates an ordinary zooming program, the ordinary zooming program comprises the following steps:
using the distance sensor to sense the limb distance between two limbs;
comparing the limb distance with the reference;
if the limb distance is greater than the reference, outputting the zooming control signal to zoom in the object; and
if the limb distance is not greater than the reference, outputting the zooming control signal to zoom out the object.

9. The input device according to claim 8, wherein when the second axis value falls in a second range, the controller initiates a continuously zooming in program, the continuously zooming in program comprises the following steps:
using the distance sensor to sense the limb distance between two limbs;
comparing the limb distance with the reference;
if the limb distance is greater than the reference, outputting the zooming control signal to zoom in the object.

10. The input device according to claim 8, wherein when the second axis value falls in a third range, the controller initiates a continuously zooming out program, the continuously zooming out program comprises the following steps:
using the distance sensor to sense the limb distance between two limbs;
comparing the limb distance with the reference;
if the limb distance is not greater than the reference, outputting the zooming control signal to zoom out the object.

11. The input device according to claim 7, wherein after the step of based on the comparison result outputting the zooming control signal to zooming the object, the zooming program further comprises the following steps:
using the motion sensor to sense the first axis value;
when the first axis value meets an ending condition, ending the zooming program; and
when the first axis value does not meet the ending condition, returning to the step of sensing the limb distance between the two limbs.

12. The input device according to claim 11, wherein the reference value is the limb distance sensed last time.

13. The input device according to claim 7, wherein the motion sensor is a G-force sensor or a gyroscope, and the distance sensor is a hall sensor, a infrared transceiver, a laser transceiver, or a ultrasonic transceiver.
